(19) United States
(12) Patent Application Publication
(10) Pub. No.: US 2013/0202342 A1
(43) Pub. Date: Aug. 8, 2013

(54) TAPE PRINTER AND TAPE PRINTER CONTROL METHOD

(71) Applicant: SEIKO EPSON CORPORATION, Tokyo (JP)

(72) Inventors: Shinsaku Kosuge, Matsumoto-shi (JP); Shigeru Takamiya, Matsumoto-shi (JP); Noriaki Murayama, Matsumoto-shi (JP)

(73) Assignee: SEIKO EPSON CORPORATION, Tokyo (JP)

(21) Appl. No.: 13/752,910

(22) Filed: Jan. 29, 2013

(30) Foreign Application Priority Data
Feb. 2, 2012 (JP) 2012-021222

(51) Int. Cl. B41J 11/66

(52) U.S. Cl. CPC B41J 11/66
USPC 400/621

(57) ABSTRACT

A tape printer including: a printing unit which performs printing on a tape-shaped printing medium having a plurality of layers; a half cutter mechanism which has a stepping motor and cuts a part of the layers of the tape-shaped printing medium after printing using a driving force of the stepping motor; and a control unit which varies driving current supplied to the stepping motor in accordance with types of the tape-shaped printing medium.

### CROSS-REFERENCE

The entire disclosure of Japanese Patent Application No. 2012-021222 filed on Feb. 2, 2012, which is hereby incorporated by reference in its entirety.

### BACKGROUND

1. Technical Field

The present invention relates to a tape printer provided with a half cutter mechanism, and a method for controlling this tape printer.

2. Related Art

There is such a type of known devices for performing printing on a tape-shaped printing medium, which includes a half cutting mechanism capable of cutting a part of plural layers formed on the tape-shaped printing medium (for example, see JP-A-2008-238825). The structure disclosed in JP-A-2008-238825 contains a gear train which connects a movable cutter of the half cutting mechanism and a DC motor for driving the movable cutter, and controls a driving force given from the DC motor to the movable cutter by using a slip clutch provided on the gear grain at the time of half cutting.

According to the structure which controls the driving force by using the slip clutch during half cutting like the device disclosed in this reference, however, the driving force of the half cutting is determined by the setting of the slip clutch and therefore is difficult to be varied. In this case, even at the time of printing on plural types of the tape-shaped printing medium different in sizes and materials, a uniform driving force is given for half cutting of all types of the tape-shaped printing medium. Accordingly, the quality of half cutting easily deteriorates and therefore is difficult to maintain.

### SUMMARY

An advantage of some aspects of the invention is to provide a tape printer equipped with a half cutter mechanism and capable of performing high-quality half cutting even when the type of a tape-shaped printing medium to be used is changed.

An aspect of the invention is directed to a tape printer including: a printing unit which performs printing on a tape-shaped printing medium having a plurality of layers in the thickness direction of the tape-shaped printing medium; a half cutter mechanism which has a stepping motor and cuts a part of the layers of the tape-shaped printing medium after printing using a driving force of the stepping motor; and a control unit which varies driving current supplied to the stepping motor in accordance with types of the tape-shaped printing medium.

According to this aspect of the invention, the driving current of the stepping motor is varied in accordance with the types of the tape-shaped printing medium during cutting of a part of the layers of the tape-shaped printing medium by using the driving force of the stepping motor. In this case, the driving force appropriate for the types of the tape-shaped printing medium is used during cutting. Accordingly, this structure achieves half cutting of the tape-shaped printing medium by using the driving force suited for the types of the tape-shaped printing medium, thereby securing stable and high-quality half cutting even when the types of the tape-shaped printing medium to be used are changed.

Another aspect of the invention is directed to the tape printer of the above aspect, wherein the half cutter mechanism cuts a part of the layers of the tape-shaped printing medium in plural sizes, and the control unit varies the driving current supplied to the stepping motor in accordance with the sizes of the tape-shaped printing medium to be processed by the half cutter mechanism.

According to this aspect of the invention, the driving current is varied in accordance with the sizes of the tape-shaped printing medium. Thus, this structure achieves half cutting of the tape-shaped printing medium by using the driving force appropriate for the respective sizes of the tape-shaped printing medium, thereby securing stable and high-quality half cutting even when the types of the tape-shaped printing medium to be used are changed.

Still another aspect of the invention is directed to the tape printer of the above aspect, wherein the control unit increases the driving current as the size of the tape-shaped printing medium becomes larger.

According to this aspect of the invention, the driving current increases as the size of the tape-shaped printing medium becomes larger. Accordingly, this structure can achieve half cutting of the tape-shaped printing medium using the driving force appropriate for the respective sizes of the tape-shaped printing medium, thereby securing stable and high-quality half cutting even when the types of the tape-shaped printing medium to be used are changed.

Yet another aspect of the invention is directed to the tape printer of the above aspect, wherein the half cutter mechanism has a cutter which cuts the tape-shaped printing medium, and cuts a part of the layers of the tape-shaped printing medium by pressing the cutter against the tape-shaped printing medium in the thickness direction of the tape-shaped printing medium by using the driving force of the stepping motor. In this case, the control unit varies the driving current supplied to the stepping motor in accordance with the types of the tape-shaped printing medium in a pressing step for pressing the cutter against the tape-shaped printing medium.

According to this aspect of the invention, the driving current supplied to the stepping motor during the pressing step where the cutter presses the tape-shaped printing medium is changed in accordance with the types of the tape-shaped printing medium so as to provide the necessary driving force. Thus, the power consumption of the half cutter mechanism decreases.

Still yet another aspect of the invention is directed to the tape printer of the above aspect, wherein the control unit decreases the driving current supplied to the stepping motor at least in anyone of steps before and after the pressing step to a level lower than the driving current supplied to the stepping motor in the pressing step.

According to this aspect of the invention, the driving current supplied at least in any of the steps before and after the pressing step is decreased to a level lower than the driving current supplied in the pressing step. This structure decreases the power consumption of the half cutter mechanism.

Further another aspect of the invention is directed to the tape printer of the above aspect, wherein the half cutter mechanism has a stopper which regulates the movement of the cutter when a part of the layers of the tape-shaped printing medium is cut. In this case, the control unit suspends supply of the driving current to the stepping motor when the load on the stepping motor increases and causes step-out of the stepping motor by the regulation of the stopper for the movement of the cutter during the pressing step.

According to this aspect of the invention, the step-out torque of the stepping motor is varied by changing the driving current supplied to the stepping motor during the pressing step, wherefore the pressing force of the cutter given to the tape-shaped printing medium varies. Accordingly, this structure achieves half cutting of the tape-shaped printing medium by using the driving force appropriate for the respective sizes of the tape-shaped printing medium, thereby securing stable and high-quality half cutting even when the types of the tape-shaped printing medium to be used are changed.

Still further another aspect of the invention is directed to a method for controlling a tape printer including: controlling a tape printer which includes a printing unit that performs printing on a tape-shaped printing medium having a plurality of layers in the thickness direction of the tape-shaped printing medium, and a half cutter mechanism that has a stepping motor and cuts a part of the layers of the tape-shaped printing medium after printing by using a driving force of the stepping motor, so as to cut the part of the layers by using the half cutter mechanism; and varying driving current supplied to the stepping motor in accordance with types of the tape-shaped printing medium in the step of cutting the part of the layers by the half cutter mechanism.

According to this aspect of the invention, the driving current of the stepping motor is varied in accordance with the types of the tape-shaped printing medium during cutting of a part of the layers of the tape-shaped printing medium using the driving force of the stepping motor. In this case, the driving force appropriate for the types of the tape-shaped printing medium is used during cutting. Accordingly, this structure achieves half cutting of the tape-shaped printing medium by using the driving force suited for the types of the tape-shaped printing medium, thereby securing stable and high-quality half cutting even when the types of the tape-shaped printing medium to be used are changed.

According to the aspects of the invention, half cutting of a tape-shaped printing medium can be performed by using driving force suited for the types of the tape-shaped printing medium, and therefore stable and high-quality half cutting can be secured even when the types of the tape-shaped printing medium to be used are changed.

### BRIEF DESCRIPTION OF THE DRAWINGS

The invention will be described with reference to the accompanying drawings, wherein like numbers reference like elements.

FIG. 1 illustrates the structure of a tape printer according to an embodiment of the invention.

FIG. 2 illustrates the structure of a main part of the tape printer as viewed from the front side of a printing tape.

FIG. 3 is a perspective view of a cutter mechanism.

FIG. 4 is a perspective view of the cutter mechanism in a disassembled condition.

FIG. 5 illustrates a cutting operation for the printing tape performed by a half cutter.

FIGS. 6A through 6E show an operation of a cutter motor, wherein: FIG. 6A shows an example of the change of the number of operation steps of the cutter motor with an elapse of time when a cutter is driven; FIG. 6B shows an example of the change of the rotation angle of a cutter driving gear with an elapse of time when the cutter is driven; FIG. 6C shows an example of the change of the number of operation steps of the cutter motor with an elapse of time when a half cutter is driven; FIG. 6D shows an example of the change of the rotation angle of the cutter driving gear with an elapse of time when the half cutter is driven; and FIG. 6E shows an example of the change of the angle of a movable cutter of the half cutter with an elapse of time.

FIGS. 7A and 7B show an operation of the cutter motor, wherein: FIG. 7A shows an example of the change of the number of revolutions of the cutter motor with an elapse of time when the half cutter is driven; and FIG. 7B shows an example of the change of driving current of the cutter motor with an elapse of time when the half cutter is driven.

FIG. 8 shows a constitution example of a table which defines driving current of the cutter motor.

FIG. 9 is a flowchart showing an operation of the tape printer.

### DESCRIPTION OF EXEMPLARY EMBODIMENTS

A tape printer 1 and a method for controlling the tape printer 1 according to an embodiment of the invention are hereinafter described with reference to the accompanying drawings. The tape printer 1 performs desired printing on a printing tape (tape-shaped printing medium) 70 delivered while drawn from a tape cartridge 2 attached to the tape printer 1, and cuts the printed portion of the printing tape 70 to obtain a desired label.

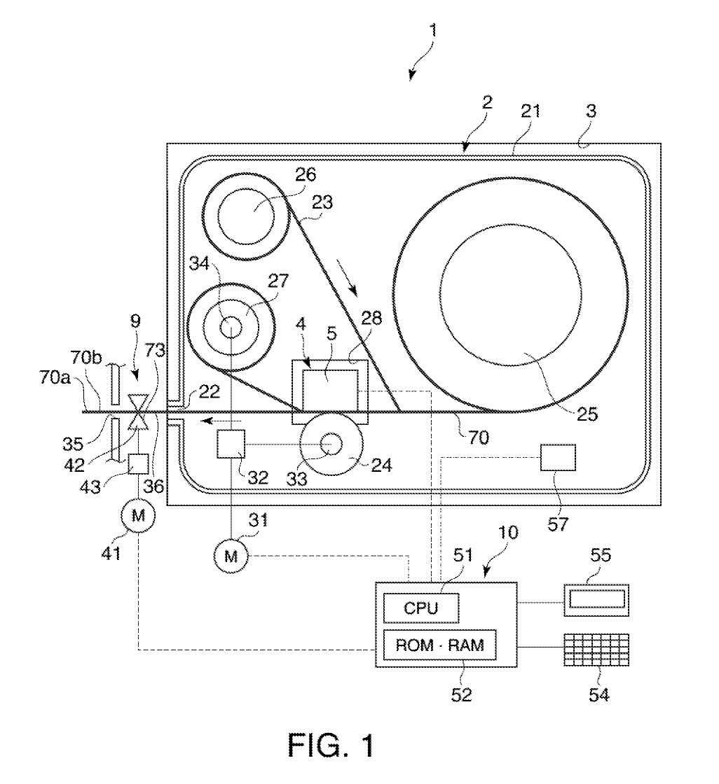

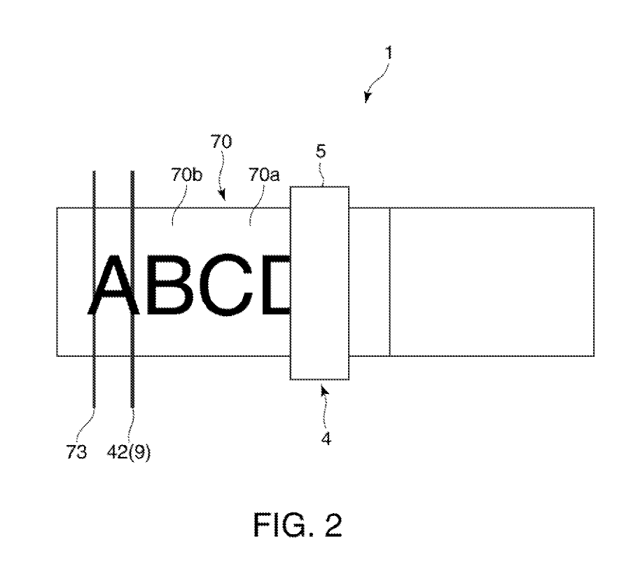

FIG. 1 schematically illustrates the structure of a main part of the tape printer 1. FIG. 2 shows the structure of a main part of the tape printer 1 as viewed from the front side of the printing tape 70.

As illustrated in FIGS. 1 and 2, the tape printer 1 includes a cartridge attachment portion 3 to which the tape cartridge 2 is detachably attached, a printing unit 4 provided with a printing head 5 which performs printing on the printing tape 70 by thermal transfer, a cutter mechanism (half cutter mechanism) 9 disposed on the downstream side with respect to the printing unit 4, and a control unit 10 which controls these components as a central controller.

The tape cartridge 2 contains the printing tape 70, an ink ribbon 23, and a platen roller 24, all housed in a cartridge case 21 which has an outlet port 22 for discharging the printing tape 70. The printing tape 70 is wound around a tape core 25 while housed, and drawn toward the outlet port 22 at the time of printing. The ink ribbon 23 is wound around a drawing core 26 while housed, and drawn to the position of the printing head 5 at the time of printing. After the printing operation, the ink ribbon 23 is delivered from the position of the printing head 5 toward a winding core 27 to be wound around the winding core 27.

The cartridge case 21 has a rectangular opening 28 at the position corresponding to the printing head 5 so that the printing head 5 can be inserted into the opening 28. The platen roller 24 of the tape cartridge 2 is disposed in such a position as to contact the printing head 5 when the printing head 5 is inserted into the opening 28 with a clearance between the printing head 5 and the opening 28.

The printing unit 4 has the printing head 5 constituted by a thermal head. The printing unit 4 holds the printing tape 70 and the ink ribbon 23 in the space between the platen roller 24 and the printing head 5, and performs thermal transfer printing while forwarding the printing tape 70 and the ink ribbon 23 in parallel. Inside the tape cartridge 2, the ink ribbon 23 overlaps with the front surface of the printing tape 70 (referred to as a printing surface 70a as will be described below). In this arrangement, the printing head 5 is located on the ink ribbon 23 side, while the platen roller 24 is located on the rear surface side of the printing tape 70.

The printing head 5 has a heating element array containing a plurality of heating elements arranged in a row in the direction of the tape width. The length of the heating element array corresponds to the maximum width of the printing tape 70 allowed for printing. According to the printing head 5 in this embodiment, therefore, the plural heating elements constituting the heating element array are selectively driven for heating based on printing data so that dot printing can be performed line by line in synchronization with the feed of printing tape 70.

The cartridge attachment portion 3 contains a feed motor 31 providing a power source, and a tape feed mechanism 32 driven by the feed motor 31 to rotate the platen roller 24 and the winding core 27. The tape feed mechanism 32 has a gear train (not shown). A platen shaft 33 and a winding shaft 34 as projections inside the cartridge attachment portion 3 are disposed on the two final gears included in the gear train.

When the tape cartridge 2 is attached to the cartridge attachment portion 3, the platen roller 24 and the winding core 27 are fitted to the platen shaft 33 and the winding shaft 34, respectively, to come into a condition for feeding the printing tape 70 and the ink ribbon 23 (feed standby condition).

When the feed motor 31 is driven in the feed standby condition, the printing tape 70 and the ink ribbon 23 are both forwarded while overlapping with each other at the position of the printing head 5. In this condition, printing is executed on the printing tape 70 by the operation of the printing head 5. The printed portion of the printing tape 70 after passing through the printing head 5 travels along a feed route 36, and passes through the outlet port 22 of the tape cartridge 2 to be discharged to the outside of the device through an outlet port 35 of the tape printer 1. On the other hand, the ink ribbon 23 is wound around the winding core 27. The platen roller 24 may be provided on the main body of the tape printer 1 instead of the tape cartridge 2. According to a specific example of this structure, the printing head 5 or the platen roller 24 shifts at the time of attachment of the tape cartridge 2 to the cartridge attachment portion 3 so as to come into the feed standby condition where the printing tape 70 and the ink ribbon 23 are held between the printing head 5 and the platen roller 24.

The cutter mechanism 9 includes a cutter motor (stepping motor) 41 providing a driving source, a cutter 42 which completely cuts the printing tape 70, a half cutter 73 which cuts a part of the layers of the printing tape 70, and a cutter operation mechanism 43 which transmits the power of the cutter motor 41 to the cutter 42 and the half cutter 73. The cutting directions of the cutter 42 and the half cutter 73 are set substantially perpendicular to the feed direction of the printing tape 70.

The control unit 10 includes a CPU 51, and a memory unit 52 containing a ROM, a RAM and others, and controls the printing head 5, the feed motor 31, and the cutter motor 41 based on control information stored in the memory unit 52. The control unit 10 connects with a keyboard 54 constituting an input unit, a display 55 constituting a display unit, and a size detection unit 57 detecting the size of the printing tape 70 of the tape cartridge 2. A user inputs desired data through the keyboard 54, and carries out editing or other operations while checking the input data displayed on the display 55. After the printing data is created in this manner, printing is performed in response to a printing command given through the keyboard 54.

The size detection unit 57 detects the size of the printing tape 70 of the attached tape cartridge 2 based on determination of the number or positions of holes (not shown) formed in the tape cartridge 2. The size of the printing tape 70 in this context corresponds to the width of the printing tape 70.

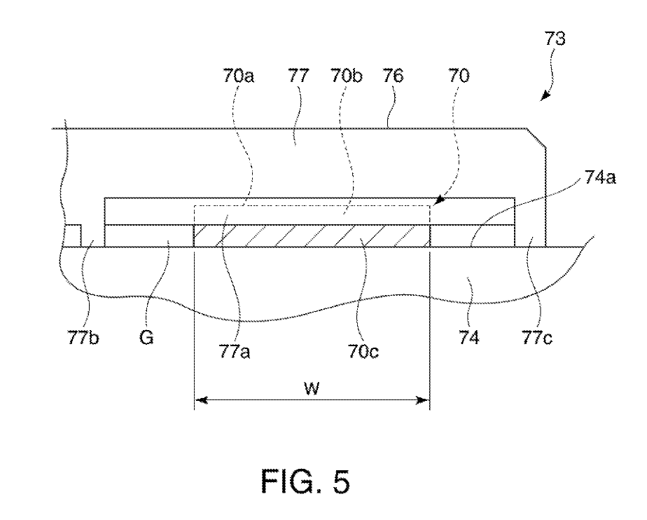

The printing tape 70 has a double-layered structure which includes a recording tape 70b having an adhesive layer on the rear surface thereof (see FIG. 5), and a release tape 70c to which the recording tape is affixed (see FIG. 5). These tapes 70b and 70c are overlapped with each other to constitute double layers. As illustrated in FIGS. 1 and 2, the front surface of the recording tape 70b forms the printing surface 70a on which printing is performed by the function of the printing head 5. More specifically, dot printing is executed line by line on the printing surface 70a of the printing tape 70 based on the printing data by selective driving of the heating element array of the printing head 5 and feed of the printing tape 70 via the platen roller 24. As a result, character images such as characters, figures, and symbols, or two-dimensional code images such as barcodes and QR codes (registered trademark) are printed, for example.

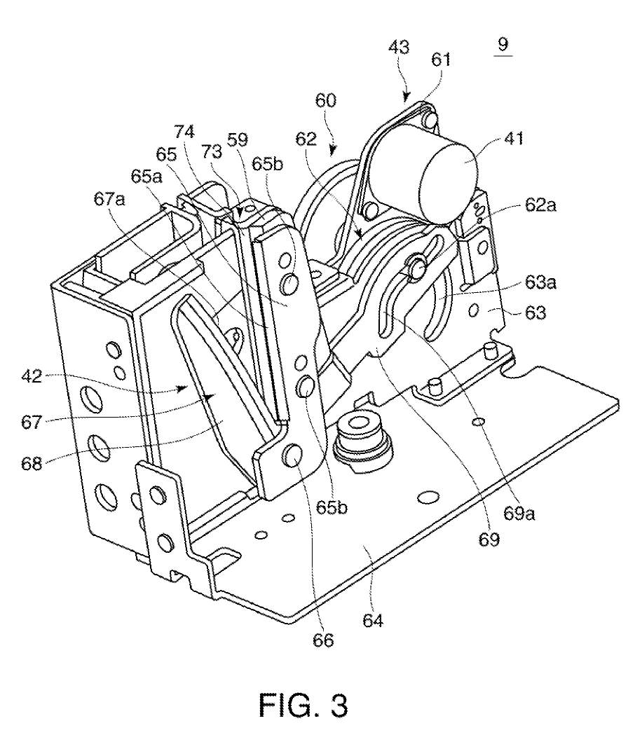

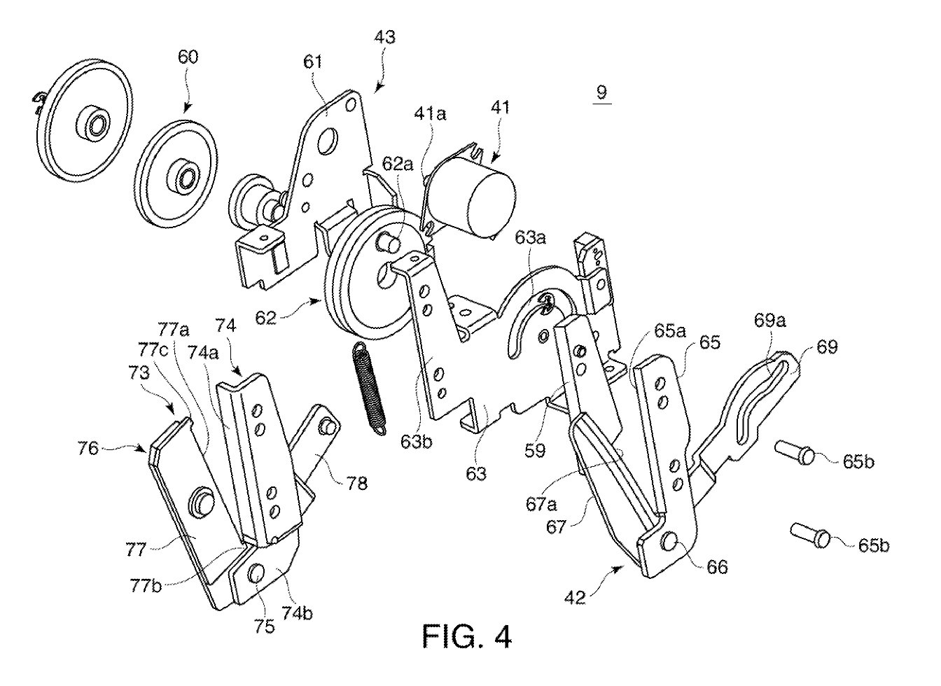

FIG. 3 is a perspective view of the cutter mechanism 9. FIG. 4 is a perspective view of the cutter mechanism 9 in a disassembled condition. FIG. 5 illustrates cutting operation for the printing tape 70 by using the half cutter 73 as viewed from the side of the half cutter 73.

As illustrated in FIGS. 3 and 4, the cutter mechanism 9 has the cutter motor 41, the cutter 42, and the half cutter 73, all supported on the cutter operation mechanism 43.

The cutter operation mechanism 43 includes a plate-shaped gear frame 61 which supports the cutter motor 41 and a transmission gear train 60 containing a plurality of gears, a cutter driving gear 62 which connects with the transmission gear train 60 and drives the cutter 42 and the half cutter 73, a plate-shaped cutter frame 63 which supports the cutter 42 and the half cutter 73, and a base plate 64 (not shown in FIG. 4) which supports the gear frame 61 and the cutter frame 63. The transmission gear train 60 and the cutter driving gear 62 correspond to a transmission mechanism for transmitting the rotation force of the cutter motor 41 to the cutter 42 and the half cutter 73. This transmission mechanism mechanically joins an output shaft (not shown) of the cutter motor 41 with the cutter 42 and the half cutter 73. Thus, loads applied to the cutter 42 and the half cutter 73 during driving are loads transmitted from the cutter motor 41 via the transmission mechanism.

The gear frame 61 and the cutter frame 63 are disposed opposed to each other on the base plate 64. The cutter driving gear 62 is disposed between the gear frame 61 and the cutter frame 63.

The cutter motor 41 is fixed to the inside surface of the gear frame 61 on the cutter driving gear 62 side. The transmission gear train 60 is supported on the outside surface of the gear frame 61. A driving shaft 41a of the cutter motor penetrates the gear frame 61 and engages with the transmission gear train 60 so that the rotation of the cutter motor 41 can be transmitted to the cutter driving gear 62 after reduction of the rotation speed by the transmission gear train 60. The cutter motor 41 constituted by a stepping motor rotates by a predetermined angle every time a pulse is inputted from the control unit 10, wherefore the number of revolutions (rotation speed) of the cutter motor 41 is determined in accordance with the frequency of the input pulses. The cutter motor 41 has such torque characteristics peculiar to a stepping motor that torque which is large in the low rotation range decreases as the rotation approaches the high rotation range.

Moreover, the cutter motor 41 has such torque characteristics peculiar to a stepping motor that step-out torque increases as driving current supplied from the control unit 10 to the cutter motor 41 rises. The step-out torque in this context corresponds to torque produced when the cutter motor 41 is difficult to rotate in accordance with the input pulses due to the presence of torque applied to the cutter motor 41 from the half cutter 73 on the load side. In other words, the cutter motor 41 stops when a load larger than the step-out torque is applied thereto.

A guide shaft 62a penetrating the cutter frame 63 and extending therefrom is provided in the vicinity of the outer circumferential surface of the cutter driving gear 62. The cutter 42 and the half cutter 73 connect with the cutter driving gear 62 via the guide shaft 62a. Each of the cutter 42 and the half cutter 73 connects with the cutter driving gear 62 so that either the cutter 42 or the half cutter 73 can be selectively operated by switching the rotation direction of the cutter motor 41 between the normal rotation and reverse rotation, the details of which mechanism will be described below.

The cutter frame 63 has a circular-arc-shaped slit 63a penetrating the cutter frame 63. The guide shaft 62a shifts within the slit 63a in accordance with the rotation of the cutter driving gear 62. A cutter fixing portion 63b to which the cutter 42 and the half cutter 73 are fixed is provided at the side edge of the outside surface of the cutter frame 63.

More specifically, the half cutter 73 is fixed to the outside surface of the cutter fixing portion 63b. The cutter 42 is disposed on the side surface of the half cutter 73 in such a position as to overlap with the half cutter 73 with a plate-shaped spacer 59 interposed between the cutter 42 and the half cutter 73. The half cutter 73 and the cutter 42 are fixed via a pair of pins 65b. Accordingly, the cutter 42 and the half cutter 73 are disposed in parallel on the feed route of the printing tape 70.

The half cutter 73 is a press-cut-type cutter which has a plate-shaped receiving member 74 fixed to the cutter fixing portion 63b, a support shaft 75 provided at the root end of the receiving member 74, and a movable cutter (cutter) rotatable relative to the receiving member 74 while supported by the support shaft 75.

The receiving member 74 has a flat receiving plate portion 74a which receives the printing tape 70, and a base end portion 74b where the support shaft 75 is provided.

The movable cutter 76 has a plate-shaped main body 77 on the base end of which the support shaft 75 is provided, and a lever 78 extended from the main body 77 and connected with the cutter driving gear 62. A cutter portion 77a which cuts apart of the printing tape 70 for half cutting is linearly extended along the side edge of the main body 77. According to the cutter mechanism 9, the cutter driving gear 62 rotates by the driving of the cutter motor 41 transmitted via the transmission gear train 60. This rotation of the cutter driving gear 62 rotates the lever 78 and thereby allows the movable cutter 76 to rotate around the support shaft 75 in the direction toward the receiving member 74 for half cutting. The speed of movement of the movable cutter 76 is determined by the number of revolutions (rotation speed) of the cutter motor 41.

A stopper 77b is provided at the root end of the main body 77, while a stopper 77c is provided at the tip of the main body 77. The stoppers 77b and 77c are both projections extended from the ends of the cutter portion 77a toward the receiving member 74.

In the process of cutting the printing tape 70 by the movable cutter 76, the movable cutter 76 approaches the receiving member 74 while rotating. When the stoppers 77b and 77c provided on the main body 77 contact the receiving plate portion 74a of the receiving member 74, the movable cutter 76 stops rotation and does not move further. FIG. 5 illustrates the condition of complete closure of the half cutter 73. The main body 77 and the receiving member 74 are constructed such that the cutter portion 77a and the receiving plate portion 74a become parallel with each other in the condition of FIG. 5. According to this structure, a clearance G is produced between the cutter portion 77a and the receiving plate portion 74a in the area between the stopper 77b and the stopper 77c by the contact between the stoppers 77b and 77c and the receiving plate portion 74a of the receiving member 74. The size of the clearance G is adjusted to a length substantially equivalent to the thickness of the release tape 70c of the printing tape 70.

In the process of cutting the printing tape 70 by the half cutter 73, the cutter portion 77a contacts the printing surface 70a of the printing tape 70 by rotation of the movable cutter 76 as illustrated in FIG. 5. When torque is applied to the movable cutter 76 by the driving force of the cutter motor 41 in this condition, the cutter portion 77a presses the recording tape 70b. According to the half cutter 73 constituted by a press-cut-type cutter, the cutter portion 77a and the receiving plate portion 74a are positioned substantially in parallel with each other in the condition of contact between the cutter portion 77a and the printing surface 70a. The cutter portion 77a in this condition presses the recording tape 70b, and cuts the recording tape 70b by one action. After the recording tape 70b is cut, the movable cutter 76 further rotates until the stoppers 77b and 77 contact the receiving plate portion 74a. In this condition, the movable cutter 76 does not move further, wherefore the load of the cutter motor 41 increases to reach step-out torque and causes the cutter motor 41 to step out. When detecting the step-out condition of the cutter motor 41, the control unit 10 suspends supply of driving current to the cutter motor 41. The cutting operation for the printing tape 70 is now completed by a series of these steps. However, the release tape 70c is left within the clearance G without cut. In other words, the half cutter 73 cuts only the recording tape 70b of the printing tape 70, and leaves the release tape 70c uncut. In this condition, the recording tape 70b can be easily removed.

After the contact between the cutter portion 77a and the printing surface 70a, a pressing force is applied to the printing tape 70 until the cutter motor 41 steps out under a control of the control unit 10. In other words, the pressing force during cutting of the printing tape 70 by the half cutter 73 is controlled by the step-out torque of the cutter motor 41. It is preferable that the step-out torque of the cutter motor 41 is controlled in such a manner as to apply the pressing force continuously until the recording tape 70b is completely cut, and allow the cutter motor 41 to step out after the recording tape 70b is cut to finish the cutting.

On the other hand, the cutter 42 includes a plate-shaped fixed cutter 65 fixed to the cutter fixing portion 63b, a support shaft 66 provided at the root end of the plate-shaped fixed cutter 65, and a movable cutter 67 supported by the support shaft 66 and rotatable relative to the fixed cutter 65. The plate-shaped spacer 59 is provided between the fixed cutter 65 and the cutter fixing portion 63b. The fixed cutter 65 is fixed to the cutter fixing portion 63b via a pair of pins 65b. The fixed cutter 65 and the movable cutter 67 extend substantially in linear directions, and have cutter portions 65a and 67a, respectively, having substantially the same length. The movable cutter 67 rotates around the support shaft 66 toward the fixed cutter 65 to hold the printing tape 70 between the cutter portions 65a and 67a and cut the printing tape 70 by the cutter portions 65a and 67a. Accordingly, the cutter 42 is constituted by a scissors-type cutter.

The movable cutter 67 has a substantially L shape, and includes a plate-shaped main body 68 provided with the cutter portion 67a, and a plate-shaped lever 69 extending from the end of the main body 68 while bended substantially in the right-angled direction with respect to the main body 68. The lever 69 has a guide slit 69a with which the guide shaft 62a of the cutter driving gear 62 engages. The movable cutter 67 rotates around the support shaft 66 by the drive of the guide shaft 62a shifting within the guide slit 69a. When the cutter driving gear 62 rotates by the revolution of the cutter motor 41, the guide shaft 62a of the cutter driving gear 62 shifts within the guide slit 69a of the lever 69. As a result, the movable cutter 67 rotates along with the lever 69 while allowing the cutter portion 67a to approach the cutter portion 65a, thereby achieving cutting of the printing tape 70 held between the cutter portions 65a and 67a. The speed of the rotation of the movable cutter 67 is determined by the number of revolutions of the cutter motor 41.

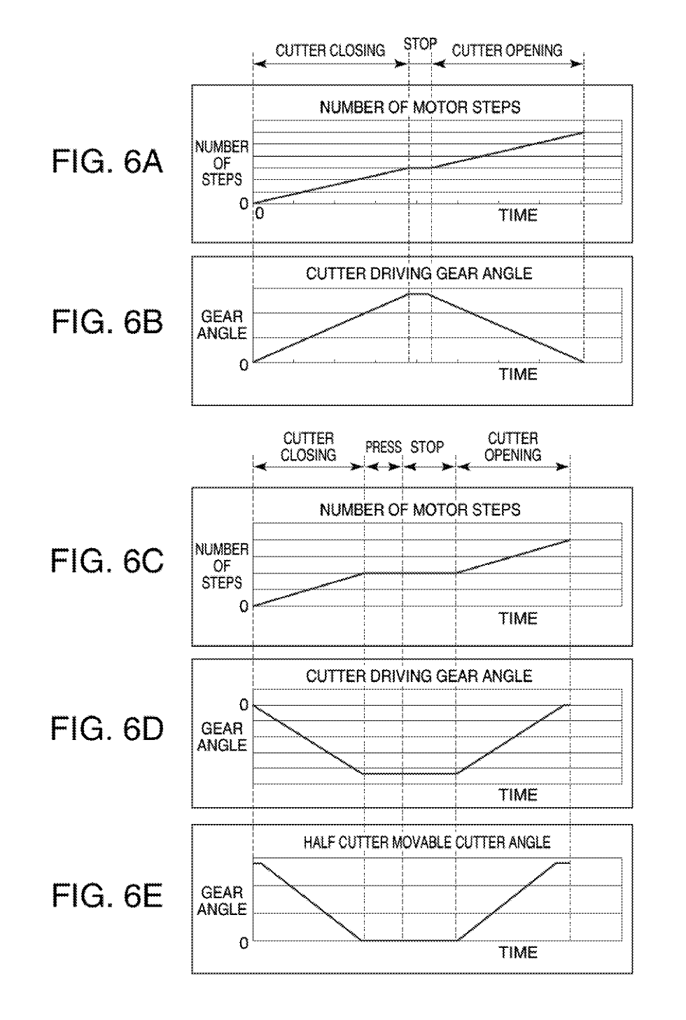

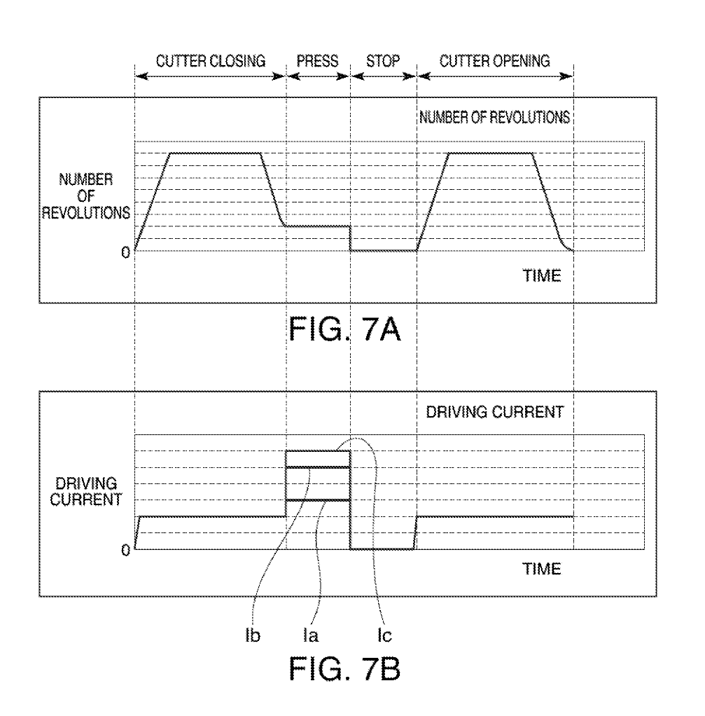

FIGS. 6A through 6E and FIGS. 7A and 7B show the operation of the cutter motor 41. FIGS. 6A and 6B are charts showing an example of the operation when the cutter 42 is driven. FIG. 6A shows an example of the change of the number of operation steps of the cutter motor 41 with an elapse of time, while FIG. 6B shows an example of the change of the rotation angle of the cutter driving gear 62 with an elapse of time.

FIGS. 6C through 6E and FIGS. 7A and 7B show an example of the operation when the half cutter 73 is driven. FIG. 6C shows an example of the change of the number of operation steps of the cutter motor 41 with an elapse of time. FIG. 6D shows an example of the change of the rotation angle of the cutter driving gear 62 with an elapse of time. FIG. 6E shows an example of the change of the rotation angle of the movable cutter 76 of the half cutter 73 with an elapse of time. FIG. 7A shows an example of the change of the number of revolutions of the cutter motor 41 with an elapse of time, while FIG. 7B shows an example of driving current of the cutter motor 41 with an elapse of time.

The cutter 42 and the half cutter 73 are both driven by the operation of the cutter driving gear 62. The cutter driving gear 62 is rotatable in the normal direction and reverse direction. The rotation direction of the cutter driving gear 62 corresponds to the normal rotation and reverse rotation of the cutter motor 41. A reference position is determined substantially at the center of the rotation range of the cutter driving gear 62. The cutter motor 41 and the cutter driving gear 62 are located at the reference position during operation standby of the cutter mechanism 9. According to the cutter mechanism 9, the cutter 42 is driven on the normal direction side with respect to the reference position, while the half cutter 73 is driven on the reverse direction side with respect to the reference position.

The rotation direction of the cutter motor 41 is switched between the normal rotation and reverse rotation by changing the voltage applied to the cutter motor 41 between the forward direction and the reverse direction under the control of the control unit 10. The number of operation steps representing the revolution amount of the cutter motor 41 is counted by the control unit 10 based on the number of driving pulses outputted to the cutter motor 41.

When the control unit 10 applies forward direction voltage to the cutter motor 41 to supply driving current and outputs driving pulses at a predetermined frequency under the standby condition of the cutter mechanism 9, the cutter motor 41 rotates in the normal rotation direction from the reference position as shown in FIG. 6A. In accordance with this rotation, the cutter driving gear 62 rotates toward the normal direction side as shown in FIG. 6B, whereby the rotation angle increases toward the normal direction side. In this case, the lever 69 rotates in accordance with the movement of the guide shaft 62a and allows the movable cutter 67 to approach the fixed cutter 65. When the number of steps of the cutter motor 41 reaches a predetermined number, the movable cutter 67 rotates to the position where the cutter 42 completely closes to finish cutting of the printing tape 70. This process is referred to as a cutter closing period. When the cutter 42 completely closes, the control unit 10 stops the cutter motor 41 for a predetermined time, during which stop the direction of the voltage applied to the cutter motor 41 is reversed. Then, the control unit 10 supplies driving current to the cutter motor 41, and again outputs driving pulses thereto to rotate the cutter motor 41 in the reverse rotation. As a result, the movable cutter 67 rotates in the reverse direction, whereby the cutter 42 opens until the position prior to the cutting operation. This process is referred to as a cutter opening period. The number of driving steps of the cutter motor 41 is counted both in the reverse direction and normal direction regardless of the rotation direction of the cutter motor 41. Thus, the count of the number of driving steps of the cutter motor 41 in the cutter opening period is continued from the count of the number of driving steps in the preceding cutter closing period.

The number of revolutions of the cutter motor 41 is determined by the frequency of the driving pulses outputted to the cutter motor 41 from the control unit 10. During the cutter closing period, the number of revolutions of the cutter motor 41 is adjusted in accordance with the level of torque necessary for cutting the printing tape 70. The torque of the cutter motor 41 as a stepping motor increases as the number of revolutions decreases. The control unit 10 controls the pulse cycle in such a condition as to produce torque appropriate for cutting the printing tape 70. On the other hand, during the cutter opening period, the load on the cutter motor 41 is only the load necessary for opening the movable cutter 67. Thus, the cutter motor 41 rotates at a high speed.

When the control unit 10 applies voltage to the cutter motor 41 in the reverse direction to supply driving current and outputs driving pulses at a predetermined frequency under the standby condition of the cutter mechanism 9, the cutter motor 41 rotates in the reverse rotation direction from the reference position. The number of driving steps of the cutter motor 41 increases as shown in FIG. 6C. In response to this rotation of the cutter motor 41, the cutter driving gear 62 rotates to the reverse direction side (negative direction in the figure) as shown in FIG. 6D. In accordance with this rotation of the cutter driving gear 62, the guide shaft 62a moves and rotates the lever 78, whereby the rotation angle of the movable cutter 76 increases to the reverse direction side (negative direction in the figure) as shown in FIG. 6E. The period ranging between the approach of the movable cutter 76 toward the receiving member 74 and the contact between the cutter portion 77a and the printing surface 70a is referred to as a cutter closing period. The control unit 10 gradually decreases the speed of the cutter motor 41 by the time when the cutter portion 77a contacts the printing surface 70a as shown in FIG. 7A. The driving current during this cutter closing period is substantially constant as shown in FIG. 7B.

After the contact between the cutter portion 77a and the printing surface 70a, the cutter motor 41 comes to a substantial stop. However, the control unit 10 continues supply of the driving current to the cutter motor 41 to apply a pressing force to the printing tape 70 via the cutter portion 77a. Then, the recording tape 70b is cut, whereby the cutter motor 41 steps out as discussed above. This period is referred to as a pressing period (pressing step).

As can be seen from FIG. 7B, the control unit 10 has a function of switching the driving current supplied to the cutter motor 41 between three steps in accordance with the size of the printing tape 70 during the pressing period.

The tape printer 1 can process the printing tape 70 having different plural sizes (widths). A size (width) W of the printing tape 70 attachable to the tape printer 1 ranges from the minimum size of 4 mm to the maximum size of 36 mm, for example. More specifically, the printing tape 70 having widths of 4 mm, 8 mm, 12 mm, 18 mm, 24 mm, and 36 mm can be used. The sizes of the printing tape 70 differ only in widths, and the thicknesses of the recording tape 70b and the release tape 70c are substantially uniform.

The size of the printing tape 70 affects the pressing force required during the pressing period. More specifically, the width of the printing tape 70 corresponds to a cutting length W (FIG. 5) of the cutter portion 77a of the movable cutter 76. The necessary pressing force during the pressing period increases as the cutting length W becomes longer. When an insufficient pressing force is applied, problems such as incomplete cut or rough cutting surface of the recording tape 70b may be caused. For preventing these problems, there is an idea that a pressing force sufficient for cutting the largest size printing tape 70 is applied to the printing tape 70, for example. However, when the pressing force applied during the pressing period is excessively large for the width of the printing tape 70, there is a possibility that the cutter portion 77a cuts the area of the release tape 70c. In this case, a cut is produced in the release tape 70c, in which condition the recording tape 70b is difficult to remove. Moreover, the larger pressing force than required consumes a larger amount of power than necessary.

According to the tape printer 1 in this embodiment, therefore, the control unit 10 varies the driving current of the cutter motor 41 in accordance with the size of the printing tape 70. The step-out torque of the cutter motor 41 changes according to the driving current. Thus, the control unit 10 changes the step-out torque of the cutter motor 41 by varying the driving current so as to apply a pressing force appropriate for the size of the printing tape 70 during the pressing period. By this control, the recording tape 70b of the printing tape 70 in any sizes can be securely cut by an appropriate pressing force with the release tape 70c remaining on the printing tape 70. Moreover, an excessively large pressing force is not applied to the printing tape 70 having a small width. Accordingly, the release tape 70c without cut can be left with high reliability, and efficient cutting of the printing tape 70 can be achieved by using only necessary cutting energy.

The control unit 10 in this embodiment switches the driving current supplied to the cutter motor 41 between three steps during the pressing period as shown in FIG. 7B. Current Ia is applied to the printing tape 70 in a smallest width group (for example, in the range from 4 mm to 12 mm in width) in the types of the printing tape 70 attachable to the tape printer 1. Current Ib higher than the current Ia is applied to the printing tape 70 having a width in the range from 18 mm to 24 mm, for example. The highest current Ic is applied to the printing tape 70 having a width of 36 mm.

During the pressing period, the cutter motor 41 slightly rotates until the stoppers 77b and 77c contact the receiving plate portion 74a after the cut of the recording tape 70b. In this case, the number of steps increases. When detecting the step-out condition of the cutter motor 41, the control unit 10 stops supply of the driving current as shown in FIG. 7B, as a period defined as a stop period. The movable cutter 76 contacts the receiving member 74 and does not move during the range from the cut of the recording tape 70b in the pressing period until the stop period. Thus, the number of steps does not change in this range.

The control unit 10 stops the cutter motor 41 for a predetermined time during the stop period. The voltage applied to the cutter motor 41 is switched to forward direction voltage during this period to shift to the opening action of the movable cutter 76. More specifically, the control unit 10 applies driving current to the cutter motor 41 for rotation and moves the movable cutter 76 in the opening direction to return the movable cutter 76 to the standby position. This step is referred to as a cutter opening period. In the cutter opening period, the load on the cutter motor 41 is not heavy similarly to the case of the cutter 42, in which condition the cutter motor 41 rotates at a high speed. The driving current during the cutter opening period is substantially constant. As can be seen from FIG. 7B, the driving current in the cutting closing period and the cutter opening period is reduced to a level lower than the driving current in the pressing period. Thus, power consumption decreases.

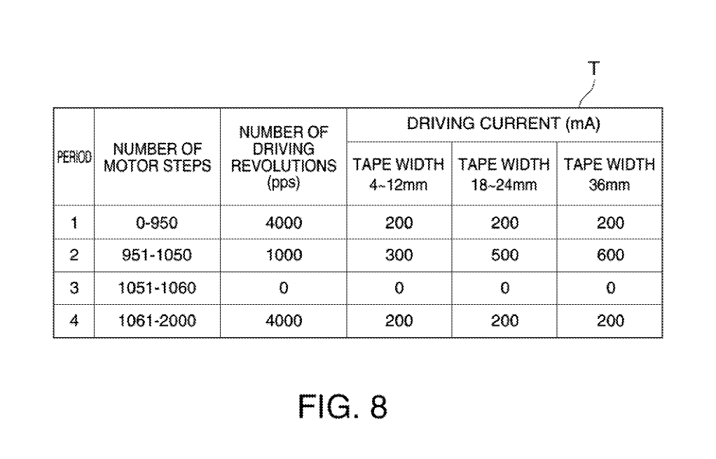

FIG. 8 shows an example of a table T which defines the driving current of the cutter motor 41.

The table T shown in FIG. 8 as an example is stored in the memory unit 52 of the control unit 10. The table T is a table which contains settings of driving current supplied to the cutter motor 41 when the half cutter 73 is driven. The table T separates the operation range of the cutter motor 41 into four periods according to the number of steps, for example, and specifies values of the driving current supplied to the cutter motor 41 for each period. According to the example shown in FIG. 8, a period 1 corresponds to the cutter closing period, a period 2 corresponds to the pressing period, a period 3 corresponds to the stop period, and a period 4 corresponds to the cutter opening period. In the cutter closing period of the period 1 and the cutter opening period of the period 4, the cutter motor 41 is accelerated and decelerated, wherefore the number of revolutions of the cutter motor 41 is not constant. The table T according to the example in FIG. 8 shows the maximum speeds of the cutter motor 41. The number of revolutions of the cutter motor 41 during acceleration and deceleration is controlled by the control unit 10 in an appropriate manner.

The driving current during the pressing period is set to different values for the respective sizes of the printing tape 70. For example, the driving current Ia for the printing tape 70 having a width in the range from 4 mm to 12 mm (FIG. 7B) is set to 300 mA, the driving current Ib for the printing tape 70 having a width in the range from 18 mm to 24 mm is set to 500 mA, and the driving current Ic for the printing tape 70 having a width of 36 mm is set to 600 mA.

The control unit 10 refers to the table T to set driving current appropriate for the size of the printing tape 70 detected by the size detection unit 57, and controls the operation of the half cutter 73 based on the setting of the driving current obtained from the table T.

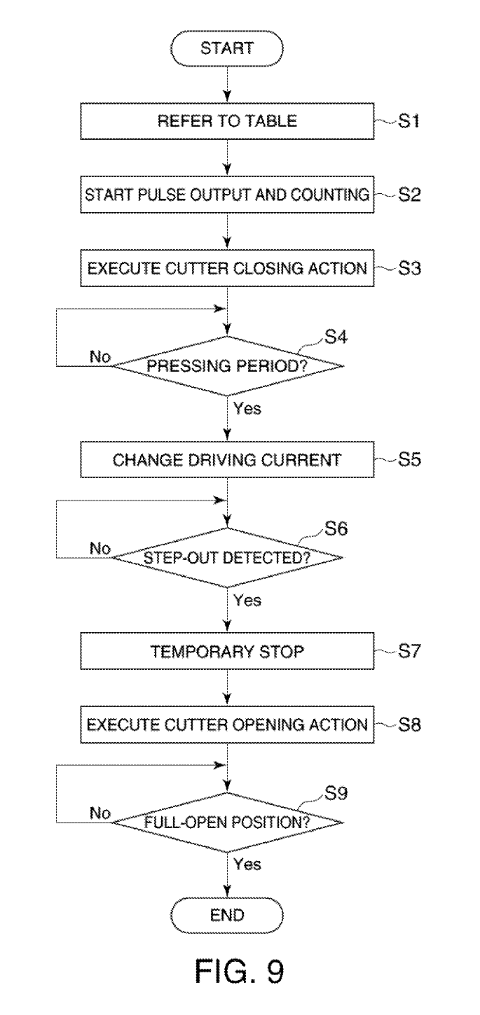

FIG. 9 is a flowchart showing the operation of the tape printer 1 for performing half cutting of the printing tape 70 by using the half cutter 73.

When the printing tape 70 is delivered to a predetermined cutting position, the control unit 10 refers to the table T stored in the memory unit 52 based on the size of the printing tape 70 detected by the size detection unit 57 (step S1). Then, the control unit 10 starts output of driving pulses to the cutter motor 41 in accordance with the setting in the table T, and initiates counting of the number of output pulses (step S2) so as to perform the cutter closing action (step S3). The number of pulses counted in this step is the number of operation steps of the cutter motor 41. The control unit 10 determines whether the number of steps has reached the upper limit in the cutter closing period established in the table T, that is, the starting position of the pressing period every time the number of steps of the cutter motor 41 increases (step S4).

When it is determined that the number of steps does not reach the pressing period (step S4: NO), the control unit 10 continues output of pulses until the number of steps reach the pressing period. When it is determined that the number of steps has reached the pressing period (step S4: YES), the control unit 10 changes the driving current of the cutter motor 41 in accordance with the setting in the table T corresponding to the size of the printing tape 70 (step S5), and checks step out of the cutter motor 41 (step S6). The control unit 10 drives the cutter motor 41 for the period until the cutter motor 41 steps out (step S6: NO), and temporarily stops the cutter motor 41 by suspension of the driving pulses to the cutter motor 41 and supply of the driving current thereto (step S7) when detecting step out (step S6: YES). The period of stop of the cutter motor 41 in the step S6 is a predetermined period defined as the minimum time required for processes such as reversing of voltage applied to the cutter motor 41. Then, the control unit 10 performs the action for the cutter opening period (step S8) where the rotation of the cutter motor 41 is reversed according to the table T to open the half cutter 73. The control unit 10 determines whether the half cutter 73 has reached the full-open standby position for each operation of the cutter motor 41 by predetermined steps, for example (step S9), and continues the operation of the cutter motor 41 until the movable cutter 76 reaches the standby position (step S9: NO). When the movable cutter 76 reaches the standby position (step S9: YES), the operation of the motor cutter 41 ends. Whether the movable cutter 76 has reached the standby position is determined based on the number of steps of the cutter motor 41, for example.

As described above, the tape printer 1 according to this embodiment of the invention includes the printing head 5 which performs printing on the printing tape 70 provided with a plurality of layers in the thickness direction of the printing tape 70, the cutter mechanism 9 which has the cutter motor 41 and cuts a part of the layers of the printing tape 70 after printing by using the driving force of the cutter motor 41, and the control unit 10 which varies the driving current supplied to the cutter motor 41 according to the types of the printing tape 70. According to this structure, the driving current of the cutter motor 41 is varied in accordance with the types of the printing tape 70 when a part of the layers of the printing tape 70 is cut by the driving force of the cutter motor 41. In this case, cutting is executed by the driving force appropriate for the types of the printing tape 70. Accordingly, this structure can perform half cutting of the printing tape 70 by using the driving force suited for the types of the printing tape 70, thereby achieving stable and high-quality half cutting even when the types of the printing tape 70 to be used are changed.

The cutter mechanism 9 has the function of cutting a part of the layers of the printing tape 70 in plural sizes. The control unit 10 varies the driving current supplied to the cutter motor 41 in accordance with the sizes of the printing tape 70 processed by the cutter mechanism 9. Thus, half cutting of the printing tape 70 can be carried out by using the driving force appropriate for the respective sizes of the printing tape 70, and stable and high-quality half cutting can be secured even when the types of the printing tape 70 to be used are changed.

The control unit 10 increases the driving current as the size of the printing tape 70 becomes larger. Accordingly, half cutting of the printing tape 70 can be carried out by using the driving force appropriate for the respective sizes of the printing tape 70, and stable and high-quality half cutting can be secured even when the types of the printing tape 70 to be used are changed.

The cutter mechanism 9 has the movable cutter 76 for cutting the printing tape 70, and cuts a part of the layers of the printing tape 70 by pressing the movable cutter 76 against the printing tape 70 in the thickness direction thereof by using the driving force of the cutter motor 41. In this case, the control unit 10 changes the driving current supplied to the cutter motor 41 during the pressing period where the movable cutter 76 presses the printing tape 70 so that the necessary driving force can be given. Thus, the power consumption of the cutter mechanism 9 decreases.

The control unit 10 reduces the driving current supplied to the cutter motor 41 at least in any of the steps before and after the pressing period to a level lower than the driving current supplied to the cutter motor 41 in the pressing period. This structure can decrease the power consumption of the cutter mechanism 9.

The cutter mechanism 9 has the stoppers 77b and 77c for regulating the movement of the movable cutter 76 when a part of the layers of the printing tape 70 is cut. The control unit 10 suspends supply of the driving current to the cutter motor 41 when the load on the cutter motor 41 increases and causes step out of the cutter motor 41 by the regulation of the stoppers 77b and 77c for the movement of the movable cutter 76 during the pressing period. In this case, the step-out torque of the cutter motor 41 changes, wherefore the pressing force of the movable cutter 76 given to the printing tape 70 varies. Accordingly, half cutting of the printing tape 70 can be carried out by using the driving force appropriate for the respective sizes of the printing tape 70, and stable and high-quality half cutting can be secured even when the types of the printing tape 70 to be used are changed.

According to this embodiment, various types of the printing tape 70 which differ in the sizes (widths) of the printing tape 70 have been discussed as an example. However, the invention is not limited to this but is applicable to a structure which uses various types of the printing tape 70 different in materials. In this case, the control unit 10 detects the material of the printing tape 70, and varies the driving current of the cutter motor 41 in accordance with the material difference while referring to the table T which specifies driving current for each of the materials of the printing tape 70.

According to this embodiment, the driving current both in the cutter closing step prior to the pressing step and in the cutter opening step after the pressing step is decreased to a level lower than the driving current of the cutter motor 41 in the pressing step. However, such a structure is allowable which decreases only the driving current at least in any one of the steps before and after the pressing step to a level lower than the driving current in the pressing step.

According to this embodiment, the tape printer 1 as a so-called thermal transfer type printer has been discussed as an example. However, the invention is not limited to the thermal transfer type printer but may be applied to various other types of printers such as an ink jet printer as long as they can perform printing on a tape-shaped recording medium and execute half cutting of the medium.

What is claimed is:

1. A tape printer, comprising:
a printing unit which performs printing on a tape-shaped printing medium having a plurality of layers;
a half cutter mechanism which has a stepping motor and cuts a part of the layers of the tape-shaped printing medium after printing using a driving force of the stepping motor; and
a control unit which varies driving current supplied to the stepping motor in accordance with types of the tape-shaped printing medium.

2. The tape printer according to claim 1, wherein
the half cutter mechanism cuts a part of the layers of the tape-shaped printing medium in plural sizes; and
the control unit varies the driving current supplied to the stepping motor in accordance with the sizes of the tape-shaped printing medium to be processed by the half cutter mechanism.

3. The tape printer according to claim 1, wherein
the half cutter mechanism cuts a part of the layers of the tape-shaped printing medium of plural types of materials; and
the control unit varies the driving current supplied to the stepping motor in accordance with the materials of the tape-shaped printing medium to be processed by the half cutter mechanism.

4. The tape printer according to claim 2, wherein the control unit increases the driving current as the size of the tape-shaped printing medium becomes larger.

5. The tape printer according to claim 1, wherein
the half cutter mechanism has a cutter which cuts the tape-shaped printing medium, and cuts a part of the layers of the tape-shaped printing medium by pressing the cutter against the tape-shaped printing medium in the thickness direction of the tape-shaped printing medium by using the driving force of the stepping motor; and
the control unit varies the driving current supplied to the stepping motor in accordance with the types of the tape-shaped printing medium in a pressing step for pressing the cutter against the tape-shaped printing medium.

6. The tape printer according to claim 5, wherein the control unit decreases the driving current supplied to the stepping motor at least in any one of steps before and after the pressing step to a level lower than the driving current supplied to the stepping motor in the pressing step.

7. The tape printer according to claim 5, wherein
the half cutter mechanism has a stopper which regulates the movement of the cutter when a part of the layers of the tape-shaped printing medium is cut; and
the control unit suspends supply of the driving current to the stepping motor when the load on the stepping motor increases and causes step-out of the stepping motor by the regulation of the stopper for the movement of the cutter.

8. A method for controlling a tape printer, comprising:
controlling a tape printer which includes a printing unit that performs printing on a tape-shaped printing medium having a plurality of layers in the thickness direction of the tape-shaped printing medium, and a half cutter mechanism that has a stepping motor and cuts a part of the layers of the tape-shaped printing medium after printing by using a driving force of the stepping motor; and
varying driving current supplied to the stepping motor in accordance with types of the tape-shaped printing medium in the step of cutting the part of the layers by the half cutter mechanism.

9. The method according to claim 8, wherein the varying driving current step varies the driving current supplied to the stepping motor in accordance with sizes of the tape-shaped printing medium to be processed by the half cutter mechanism.

10. The method according to claim 8, wherein the varying driving current step varies the driving current supplied to the stepping motor in accordance with the materials of the tape-shaped printing medium to be processed by the half cutter mechanism.

11. The method according to claim 9, wherein the varying driving current step increases the driving current as the size of the tape-shaped printing medium becomes larger.

12. The method according to claim 8, wherein the varying driving current step varies the driving current supplied to the stepping motor in accordance with the types of the tape-shaped printing medium in a pressing step for pressing a cutter against the tape-shaped printing medium in the thickness direction of the tape-shaped printing medium by using the driving force of the stepping motor to cut a part of the layers of the tape-shaped printing medium.

13. The method according to claim 12, wherein the varying driving current step decreases the driving current supplied to the stepping motor at least in any one of steps before and after the pressing step to a level lower than the driving current supplied to the stepping motor in the pressing step.

14. The tape printer according to claim 12, wherein
the controlling step suspends supply of the driving current to the stepping motor when the load on the stepping motor increases and causes step-out of the stepping motor by a stopper which regulates the movement of the cutter when a part of the layers of the tape-shaped printing medium is cut.
